(19) United States
(12) Patent Application Publication
(10) Pub. No.: US 2024/0403176 A1
(43) Pub. Date: Dec. 5, 2024

(54) DATA COLLECTION APPARATUS, DATA COLLECTION METHOD, COMPUTER READABLE MEDIUM, AND DATA COLLECTION SYSTEM

(71) Applicant: Mitsubishi Electric Corporation, Tokyo (JP)

(72) Inventors: Akiho MIURA, Tokyo (JP); Satoshi KAEDE, Tokyo (JP)

(73) Assignee: Mitsubishi Electric Corporation, Tokyo (JP)

(21) Appl. No.: 18/799,246

(22) Filed: Aug. 9, 2024

Related U.S. Application Data
(63) Continuation of application No. PCT/JP2022/005974, filed on Feb. 15, 2022.

(51) Int. Cl. G06F 11/20

(52) U.S. Cl. CPC G06F 11/2033; G06F 11/2002

(57) ABSTRACT

A data collection apparatus (10) receives failure information indicating a failed device that is a device (60) in which a failure has been detected. Then, the data collection apparatus (10) identifies a similar device that is the device (60) to be monitored that is similar to the failed device indicated by the failure information. The data collection apparatus (10) sets, as a target monitoring apparatus (70), a monitoring apparatus (70) that monitors the similar device among a plurality of monitoring apparatuses (70), and transmits an instruction signal to increase a transmission amount of operation data of the similar device to the target monitoring apparatus (70).

### CROSS REFERENCE TO RELATED APPLICATIONS

This application is a Continuation of PCT International Application No. PCT/JP2022/005974, filed on Feb. 15, 2022, all of which is hereby expressly incorporated by reference into the present application.

### TECHNICAL FIELD

The present disclosure relates to a technology to collect data indicating signs of failure occurrences.

### BACKGROUND ART

The railway business, the power generation business, and the like are businesses related to social infrastructure where continuous operation is extremely important. In such businesses, initiatives related to condition-based maintenance are actively being carried out. In condition-based maintenance, a sensor is attached to a device, and operation data of the device is acquired and accumulated. Then, by analyzing the accumulated operation data, a failure sign of the device is detected.

The operation data of the device acquired by the sensor is collected by a monitoring apparatus that is provided in a composition in which the device is installed and monitors failure signs. The monitoring apparatus transmits the operation data to a data collection apparatus that accumulates and analyzes the operation data.

In order to realize highly accurate condition-based maintenance, it is necessary to collet big data. However, the transmission bandwidth for transmitting operation data from many monitoring apparatuses installed in remote locations is limited. Therefore, it is difficult to constantly transmit detailed data of all devices from remote locations and collect a huge amount of operation data required for highly accurate condition-based maintenance into the data collection apparatus.

Therefore, in order to realize highly accurate condition-based maintenance, it is necessary to prioritize collection of operation data of high importance.

Patent Literature 1 describes storing measurement data of a longer period prior to an anomaly detection time point when there is a high failure probability than when there is a low failure probability. As a result, in Patent Literature 1, highly necessary data is stored while reducing the amount of data to be stored.

### CITATION LIST

### Patent Literature

Patent Literature 1: WO 2016/199210 A1

### SUMMARY OF INVENTION

### Technical Problem

Data indicating signs of failure occurrences has a high degree of importance for realizing highly accurate condition-based maintenance. The technology described in Patent Literature 1 collects data regarding devices in which anomalies have occurred. However, the technology described in Patent Literature 1 cannot collect data by focusing on devices in which anomalies have not occurred, that is, devices before failures occur. Therefore, the technology described in Patent Literature 1 cannot sufficiently collect data indicating signs of failure occurrences.

An object of the present disclosure is to make it possible to sufficiently collect data indicating signs of failure occurrences.

### Solution to Problem

A data collection apparatus according to the present disclosure includes
a data reception unit to receive failure information indicating a failed device from one monitoring apparatus of one or more monitoring apparatuses each of which monitors a monitoring target device, the failed device being a device in which a failure has been detected;
a similar device identification unit to identify a similar device that is the monitoring target device similar to the failed device indicated by the failure information received by the data reception unit; and
a signal transmission unit to set, as a target monitoring apparatus, a monitoring apparatus that monitors the similar device identified by the similar device identification unit among the one or more monitoring apparatuses, and transmit an instruction signal to increase a transmission amount of operation data of the similar device to the target monitoring apparatus.

### Advantageous Effects of Invention

In the present disclosure, a transmission amount of operation data regarding a similar device similar to a failed device is increased. This makes it possible to collect operation data by focusing on devices in which failures are likely to occur in the future. As a result, it is possible to sufficiently collect data indicating signs of failure occurrences.

### BRIEF DESCRIPTION OF DRAWINGS

FIG. 1 a configuration diagram of a data collection system 100 according to Embodiment 1;

FIG. 2 is a configuration diagram of a data collection apparatus 10 according to Embodiment 1;

FIG. 3 is a configuration diagram of a monitoring apparatus 70 according to Embodiment 1;

FIG. 4 is a flowchart illustrating a flow of operation of the data collection system 100 according to Embodiment 1;

FIG. 5 is a figure describing data stored in an operation data storage unit 31 according to Embodiment 1;

FIG. 6 is a flowchart of a similar device identification process according to Embodiment 1;

FIG. 7 is a figure describing data stored in a device information storage unit 32 according to Embodiment 1;

FIG. 8 is a configuration diagram of the data collection apparatus 10 according to Embodiment 2;

FIG. 9 is flowchart illustrating a flow of operation of the data collection system 100 according to Embodiment 2;

FIG. 10 is a configuration diagram of the data collection apparatus 10 according to Embodiment 3;

FIG. 11 is a flowchart illustrating a flow of operation of the data collection system 100 according to Embodiment 3;

FIG. 12 is a configuration diagram of the data collection apparatus 10 according to Embodiment 4; and

FIG. 13 is a flowchart illustrating a flow of operation of the data collection system 100 according to Embodiment 4.

### DESCRIPTION OF EMBODIMENTS

### Embodiment 1

### ***Description of Configuration***

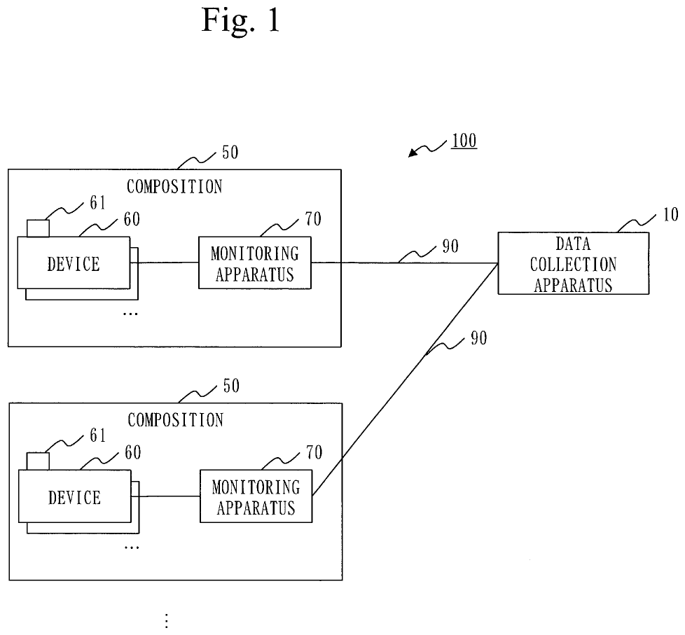

Referring to FIG. 1, a configuration of a data collection system 100 according to Embodiment 1 will be described.

The data collection system 100 includes a data collection apparatus 10 and one or more compositions 50. The data collection apparatus 10 and each composition 50 are connected through a transmission channel 90. A specific example of the transmission channel 90 is a WAN. WAN is an abbreviation for wide area network.

The data collection apparatus 10 is a computer that collects operation data of a device 60. The composition 50 includes one or more devices 60 and a monitoring apparatus 70. The composition 50 is a railway vehicle, a power generation plant, or an elevator, for example. In Embodiment 1, the composition 50 will be described as a railway vehicle.

The device 60 is a monitoring target in which signs of failures are to be monitored. The device 60 is equipped with one or more sensors 61. The sensor 61 acquires operation data regarding the device 60. The monitoring apparatus 70 is a computer that monitors the monitoring target device 60.

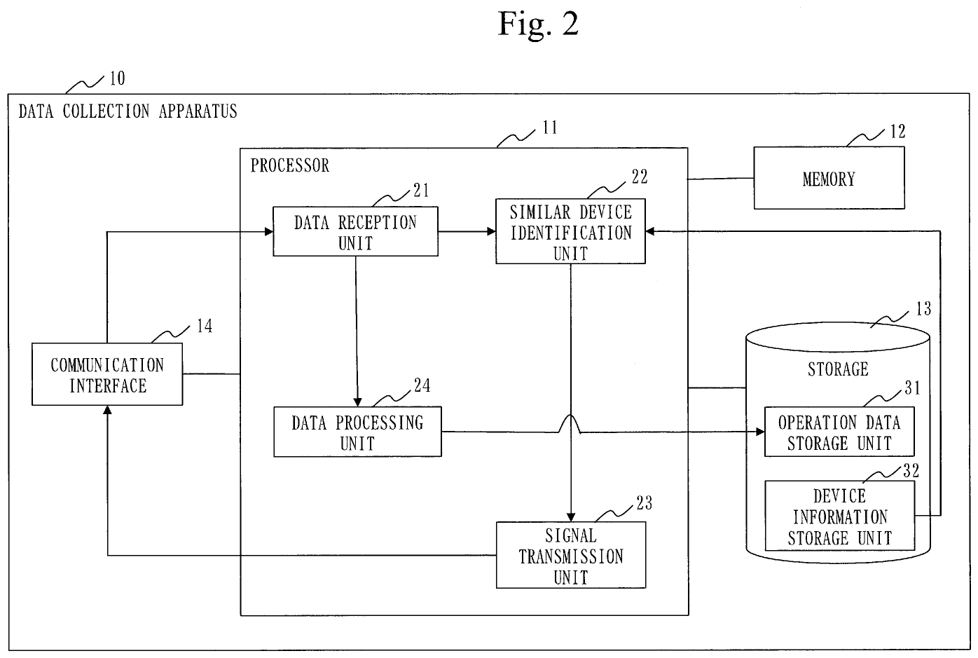

Referring to FIG. 2, a configuration of the data collection apparatus 10 according to Embodiment 1 will be described.

The data collection apparatus 10 includes hardware of a processor 11, a memory 12, a storage 13, and a communication interface 14. The processor 11 is connected with other hardware components through signal lines and controls these other hardware components.

The data collection apparatus 10 includes, as functional components, a data reception unit 21, a similar device identification unit 22, a signal transmission unit 23, and a data processing unit 24. The functions of the functional components of the data collection apparatus 10 are realized by software.

The storage 13 stores programs that realize the functions of the functional components of the data collection apparatus 10. These programs are read into the memory 12 by the processor 11 and executed by the processor 11. This realizes the functions of the functional components of the data collection apparatus 10.

The storage 13 realizes an operation data storage unit 31 and a device information storage unit 32.

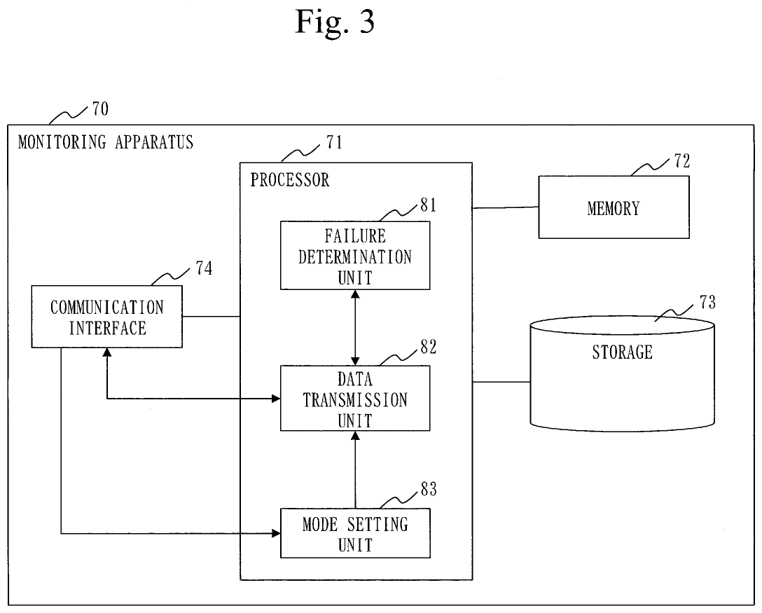

Referring to FIG. 3, a configuration of the monitoring apparatus 70 according to Embodiment 1 will be described.

The monitoring apparatus 70 includes hardware of a processor 71, a memory 72, a storage 73, and a communication interface 74. The processor 71 is connected with other hardware components through signal lines and controls these other hardware components.

The monitoring apparatus 70 includes, as functional components, a failure determination unit 81, a data transmission unit 82, and a mode setting unit 83. The functions of the functional components of the monitoring apparatus 70 are realized by software.

The storage 73 stores programs that realize the functions of the functional components of the monitoring apparatus 70. These programs are read into the memory 72 by the processor 71 and executed by the processor 71. This realizes the functions of the functional components of the monitoring apparatus 70.

Each of the processors 11 and 71 is an IC that performs processing. IC is an abbreviation for integrated circuit. Specific examples of each of the processors 11 and 71 are a CPU, a DSP, and a GPU. CPU is an abbreviation for central processing unit. DSP is an abbreviation for digital signal processor. GPU is an abbreviation for graphics processing unit.

Each of the memories 12 and 72 is a storage device to temporarily store data. Specific examples of each of the memories 12 and 72 are an SRAM and a DRAM. SRAM is an abbreviation for static random access memory. DRAM is an abbreviation for dynamic random access memory.

Each of the storages 13 and 73 is a storage device to store data. A specific example of each of the storages 13 and 73 is an HDD. HDD is an abbreviation for hard disk drive. Alternatively, each of the storages 13 and 73 may be a portable recording medium such as an SD (registered trademark) memory card, CompactFlash (registered trademark), a NAND flash, a flexible disk, an optical disc, a compact disc, a Blu-ray (registered trademark) disc, and a DVD. SD is an abbreviation for Secure Digital. DVD is an abbreviation for digital versatile disk.

Each of the communication interfaces 14 and 74 is an interface for communicating with external devices. Specific examples of each of the communication interfaces 14 and 74 are an Ethernet (registered trademark) port, a USB port, and an HDMI (registered trademark) port. USB is an abbreviation for Universal Serial Bus. HDMI is an abbreviation for High-Definition Multimedia Interface.

In FIG. 2, only one processor 11 is illustrated. However, there may be a plurality of processors 11, and the plurality of processors 11 may cooperate to execute the programs that realize the functions. Similarly, in FIG. 3, only one processor 71 is illustrated. However, there may be a plurality of processors 71, and the plurality of processors 71 may cooperate to execute the programs that realize the functions.

### ***Description of Operation***

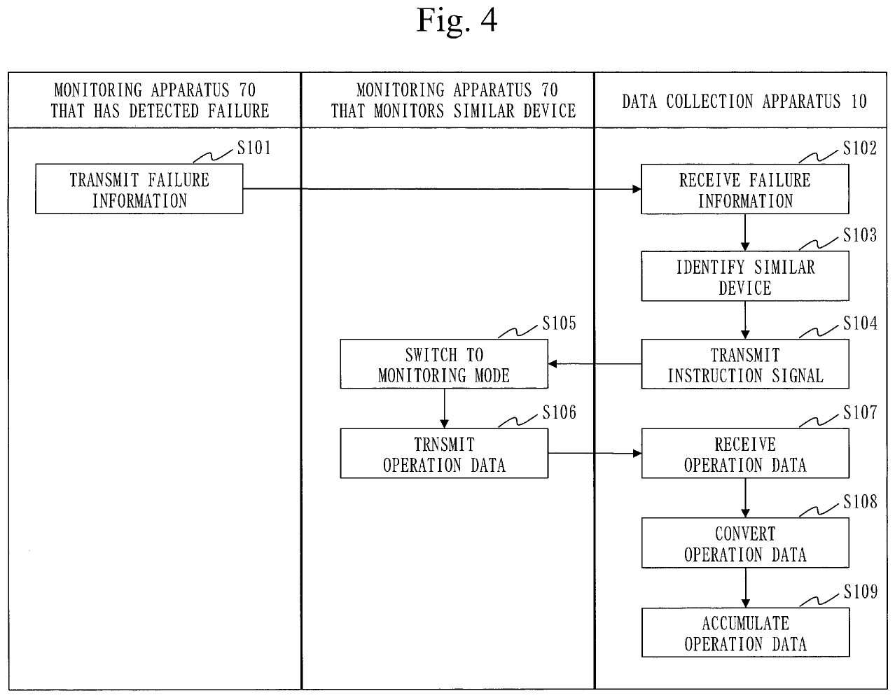

Referring to FIGS. 4 to 7, operation of the data collection system 100 according to Embodiment 1 will be described.

A procedure for the operation of the data collection apparatus 10 in the data collection system 100 according to Embodiment 1 is equivalent to a data collection method according to Embodiment 1. A program that realizes the operation of the data collection apparatus 10 in the data collection system 100 according to Embodiment 1 is equivalent to a data collection program according to Embodiment 1.

Referring to FIG. 4, a flow of the operation of the data collection system 100 according to Embodiment 1 will be described.

It is assumed that each of one or more monitoring apparatuses 70 periodically acquires sensing data from the sensor 61 installed in the device 60 included in the same composition 50. It is assumed that in each of the one or more monitoring apparatuses 70, a normal mode is set as an operation mode concerning all the devices 60. In the normal mode, the monitoring apparatus 70 transmits normal data, which is part of sensing data obtained from the sensor 61 while the device 60 is operating, at a normal cycle as operation data.

### (Step S101: Failure Information Transmission Process)

One monitoring apparatus 70 of the one or more monitoring apparatuses 70 detects a failure concerning one of the devices 60. Then, the monitoring apparatus 70 that has detected the failure transmits failure information indicating a failed device, which is the device 60 that has failed, to the data collection apparatus 10.

Specifically, in each of the monitoring apparatuses 70, the failure determination unit 81 determines whether each of the devices 60 has failed based on operation data. The failure determination unit 81 sets the device 60 that has been determined to have failed as a failed device. An existing technology may be used to determine whether a failure has occurred. In each of the monitoring apparatuses 70, if it is determined that a failure has occurred, the data transmission unit 82 transmits failure information indicating a failed device to the data collection apparatus 10. The failure information is, as a specific example, information including identification information of the failed device and operation data of the failed device. Here, the failed device is set and the failure information is transmitted in one of the monitoring apparatuses 70.

### (Step S102: Failure Information Reception Process)

The data reception unit 21 of the data collection apparatus 10 receives the failure information transmitted in step S101.

### (Step S103: Similar Device Identification Process)

The similar device identification unit 22 of the data collection apparatus 10 identifies a similar device, which is the monitoring target device 60 similar to the failed device indicated by the failure information received in step S102. The similar device identification process will be described in detail later.

### (Step S104: Signal Transmission Process)

The signal transmission unit 23 of the data collection apparatus 10 sets the monitoring apparatus 70 that monitors the similar device identified in step S103 as a target monitoring apparatus 70 among the one or more monitoring apparatuses 70. Then, the signal transmission unit 23 transmits, to the target monitoring apparatus 70, an instruction signal to increase a transmission amount of operation data of the similar device.

Specifically, the signal transmission unit 23 transmits, to the target monitoring apparatus 70, an instruction signal to switch the operation mode concerning the similar device from the normal mode to a monitoring mode. In the monitoring mode, the monitoring apparatus 70 performs at least one of transmitting detailed data that is more detailed than normal data among sensing data as operation data and transmitting operation data at a shorter cycle than the normal cycle. That is, the monitoring mode is an operation mode in which a larger volume of operation data is acquired than in the normal mode. In Embodiment 1, it is assumed that detailed data is transmitted as operation data.

### (Step S105: Mode Setting Process)

The mode setting unit 83 of the target monitoring apparatus 70 receives the instruction signal transmitted in step S104. Then, the mode setting unit 83 switches the operation mode concerning the similar device from the normal mode to the monitoring mode.

### (Step S106: Operation Data Transmission Process)

The data transmission unit 82 of the target monitoring apparatus 70 extracts detailed data from sensing data and sets it as operation data. Then, the data transmission unit 82 transmits the operation data to the data collection apparatus 10.

In each monitoring apparatus 70 other than the target monitoring apparatus 70, the data transmission unit 82 extracts normal data from sensing data and sets it as operation data. Then, the data transmission unit 82 transmits the operation data to the data collection apparatus 10.

### (Step S107: Operation Data Reception Process)

The data reception unit 21 of the data collection apparatus 10 receives the operation data transmitted in step S106.

### (Step S108: Data Conversion Process)

The data processing unit 24 of the data collection apparatus 10 performs data processing on the operation data received in step S107. Specifically, the data processing unit 24 converts the operation data into a format suitable for analysis or the like. For example, when the operation data is binary data, it is conceivable to convert the operation data into decimal numbers.

If the operation data is accumulated as it is, the data conversion process can be omitted.

### (Step S109: Data Accumulation Process)

The data processing unit 24 of the data collection apparatus 10 writes the operation data converted in step S108 to the operation data storage unit 31. As will be described later, a similarity degree and an importance degree are calculated for each similar device in step S103. Therefore, in association with the operation data concerning each similar device, the data processing unit 24 writes the similarity degree and the importance degree of that similar device to the operation data storage unit 31.

For the devices 60 other than each similar device, the data processing unit 24 writes only operation data to the operation data storage unit 31.

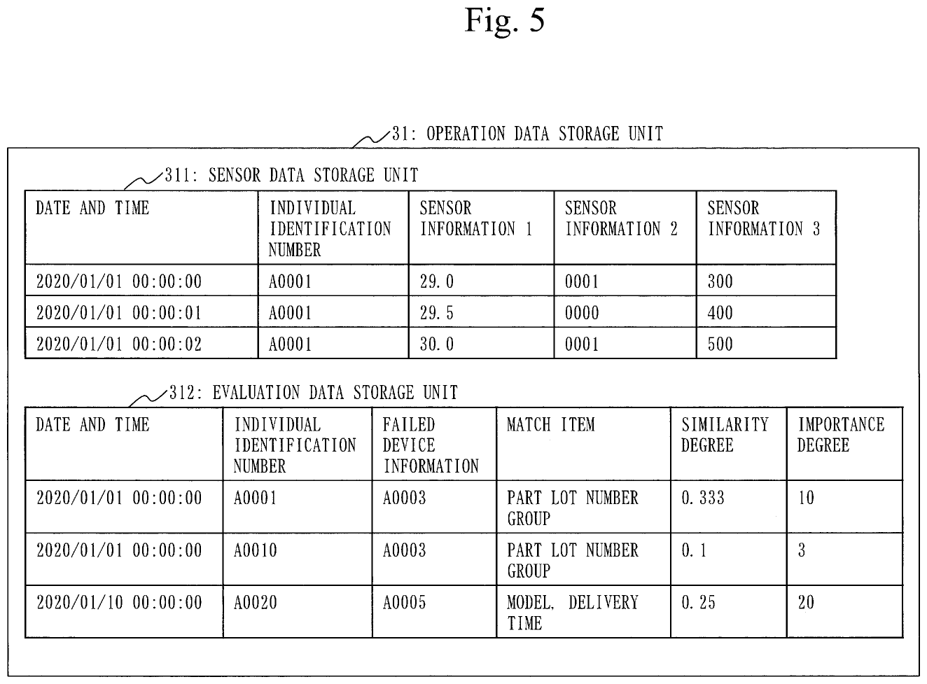

Referring to FIG. 5, data stored in the operation data storage unit 31 according to Embodiment 1 will be described.

The operation data storage unit 31 includes a sensor data storage unit 311 and an evaluation data storage unit 312.

The sensor data storage unit 311 stores operation data. The sensor data storage unit 311 stores a date and time, an individual identification number, and sensor information.

The date and time is a date and time at which a record is written to the sensor data storage unit 311. The individual identification number is identification information of the device 60 that is the subject of operation data. The sensor information is sensing data obtained from the sensor 61 installed in the device 60 that is the subject of operation data. The sensing data is a temperature, an ON value or an OFF value of a relay circuit, a pressure value, or the like.

In FIG. 5, three pieces of sensing data are stored as each set of sensor information. However, the number of pieces of sensor information may be any number. The number of pieces of sensor information may be different for each device 60. Even for the same device 60, the number of pieces of sensor information may vary depending on whether the operation mode is the normal mode or the monitoring mode. When the operation mode is the monitoring mode, it is assumed that more pieces of sensor information are obtained than when the operation mode is the normal mode.

The evaluation data storage unit 312 stores evaluation data regarding each similar device. The evaluation data storage unit 312 stores a date and time, an individual identification number, failed device information, a match item, a similarity degree, and an importance degree.

The date and time is a date and time at which a record is written to the evaluation data storage unit 312. As the date and time, the same value as the value of a corresponding record in the sensor data storage unit 311 is stored. The individual identification number is identification information of the device 60 that is the subject of operation data. The failed device information is identification information of a failed device to which a similar device is identified as being similar. The match item is an item in which a match has occurred between the similar device and the failed device. The similarity degree is a degree of similarity between the similar device and the failed device. The importance degree is an indicator that indicates severity of a failure if the failure occurs in the similar device.

The data processing unit 24 may assign an index to each of the similarity degree and the importance degree and then write them to the operation data storage unit 31. When indexes are assigned, similarity degrees and importance degrees are stored in sequence. Therefore, it is possible to quickly search for operation data of a similar device with a high similarity degree and a high importance degree. As a result, convenience when analyzing operation data is improved.

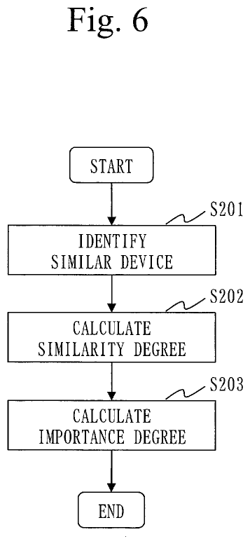

Referring to FIG. 6, the similar device identification process (step S103 in FIG. 4) according to Embodiment 1 will be described.

### (Step S201: Device Identification Process)

The similar device identification unit 22 refers to the device information storage unit 32, and identifies the device 60 similar to the failed device indicated by the failure information as a similar device.

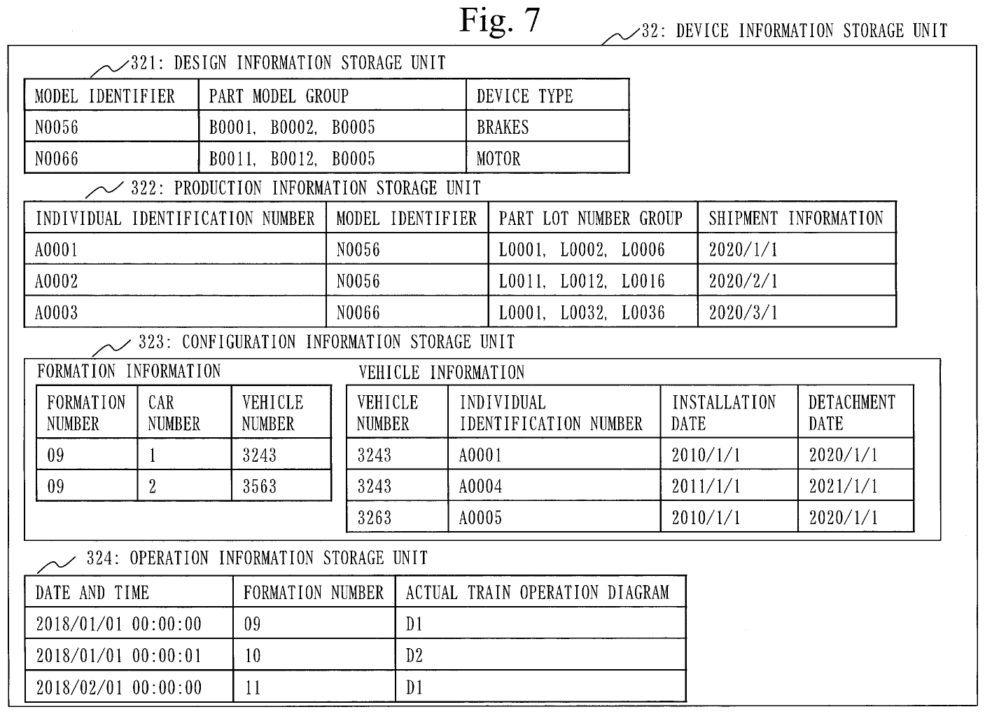

Referring to FIG. 7, data stored in the device information storage unit 32 according to Embodiment 1 will be described.

The device information storage unit 32 includes a design information storage unit 321, a production information storage unit 322, a configuration information storage unit 323, and an operation information storage unit 324.

The design information storage unit 321 stores design information of the device 60. The design information storage unit 321 stores a model identifier, a part model group, and a device type.

The model identifier is identification information of a designed component. The part model group is one or more part models. A part model is a model of a part that is a constituent of the designed component. The device type is information representing a type of the device 60. When the composition 50 in which the device 60 is installed is a railway vehicle, the device type may be brakes, a motor, or an air conditioner, for example.

The production information storage unit 322 stores information generated in the production process of the device 60. The production information storage unit 322 stores an individual identification number, a model identifier, a part lot number group, and shipment information.

The individual identification number is identification information of the device 60 that has been produced. The model identifier is information for associating with design information used in production. The model identifier corresponds to the model identifier stored in the design information storage unit 321. The part lot number group includes a lot number of each of one or more parts that are constituents of the device 60. The part lot number group includes a lot number of each part indicated by the part model group in corresponding design information. A lot number is information for identifying a part used in production. The shipment information is information indicating a date and time of shipment of the device 60.

The configuration information storage unit 323 stores information on the composition 50 in which the device 60 is installed.

In Embodiment 1, the composition 50 is a railway vehicle. The configuration information storage unit 323 stores formation information and vehicle information. The formation information includes a formation number, a car number, and a vehicle number. The vehicle information includes a vehicle number, an individual identification number, an installation date, and a detachment date.

The formation number is identification information of a train formation. The train formation is composed of one or more railway vehicles. The car number is a position of a railway vehicle in the train formation. The vehicle number is identification information of the railway vehicle. The individual identification number is identification information of the device 60. The installation date is a date on which the device 60 is installed (fitted) in the railway vehicle. The detachment date is a date on which the device 60 is detached from the railway vehicle.

The operation information storage unit 324 stores data indicating the operation status of the device 60 in chronological order. The operation information storage unit 324 stores a date and time, a formation number, and an actual train operation diagram.

The date and time is a date and time at which operation information is written. The formation number is identification information of a train formation. The actual train operation diagram is a number of a train operation diagram actually traveled by the train in an operation schedule of the train.

The similar device identification unit 22 searches the device information storage unit 32 for a similar device that is similar to the failed device. Specifically, the similar device identification unit 22 determines whether the monitoring target device 60 is similar to the failed device, depending on whether a match occurs between the monitoring target device 60 and the failed device regarding at least one of the following (A) to (D): (A) the model of the device 60, (B) the parts constituting the device 60, (C) the formation of the composition 50 in which the device 60 is installed, and (D) the usage status of the composition 50 in which the device 60 is installed.

A match in (C) means at least one of (C1) a match in the model of the device 60 that coexists in the composition 50 and (C2) a match in the system configuration of the composition 50. (C1) means that a match occurs between the model of the device 60 other than the failed device in the composition 50 in which the failed device is installed and the model of the device 60 other than the similar device in the composition 50 in which the similar device is installed. (C2) means that a match occurs between the composition 50 in which the failed device is installed and the composition 50 in which the similar device is installed in terms of configuration such as the number of vehicles and the number of installed devices.

The usage status of (D) means at least one of the delivery time, cumulative operating time, cumulative mileage, history of train operation diagrams actually traveled of the composition 50.

As a specific example, the similar device identification unit 22 uses (A) to determine the device 60 in which the model of the device 60 matches that of the failed device as a similar device. In this case, the similar device identification unit 22 extracts the device 60 whose model identifier matches that of the failed device in the production information storage unit 322. This allows the similar device identification unit 22 to identify the similar device.

As another specific example, the similar device identification unit 22 uses (A) and (B) to identify a similar device as described below. First, the similar device identification unit 22 determines the device 60 in which the model of the device 60 and the lot numbers of parts constituting the device 60 match those of the failed device as a similar device. In this case, the similar device identification unit 22 extracts the device 60 whose model identifier and part lot number group match those of the failed device in the production information storage unit 322. This allows the similar device identification unit 22 to identify the similar device.

### (Step S202: Similarity Degree Calculation Process)

The similar device identification unit 22 calculates a similarity degree that indicates a degree of similarity with the failed device for each of one or more similar devices identified in step S201. The similarity degree is an indicator that indicates how similar a similar device is to the failed device.

As a specific example, the similar device identification unit 22 compares the constituent parts of the similar device with the constituent parts of the failed device, and sets a high similarity degree if there are many matching parts. This method for calculating a similarity degree is effective when the above (A) is used to determine the device 60 in which the model of the device 60 matches that of the failed device as the similar device, for example.

A procedure for calculating a similarity degree using the constituent parts of the device 60 is as described below.
(1) The similar device identification unit 22 extracts a record that matches the individual identification number of the similar device from the individual identification numbers in the production information storage unit 322. Then, the similar device identification unit 22 acquires the model identifier of the extracted record. (2) The similar device identification unit 22 searches for the model identifier acquired in (1) from among the model identifies in the design information storage unit 321, and acquires the part model group of an applicable record. As a result, the constituent parts of the similar device are acquired.

It is assumed that the constituent parts of the similar device are B0001, B0002, and B0005. The constituent parts of the failed device are also identified similarly. It is assumed that the constituent parts of the failed device are B0011, B0012, and B0005. In this case, a match occurs in one of the three constituent parts between the similar device and the failed device. Therefore, the similar device identification unit 22 calculates the similarity degree as ⅓=0.333.

### (Step S203: Importance Degree Calculation Process)

The similar device identification unit 22 calculates an importance degree for each of one or more similar devices identified in step S201. The importance degree is an indicator that indicates severity if a failure occurs in a similar device.

Specifically, the similar device identification unit 22 calculates an importance degree so that a similar device with the following characteristics (A′) and (B′) has a high importance degree: (A′) a high deterioration degree and (B′) a failure is expected to cause significant damage.

A procedure for calculating an importance degree using the above characteristics is as described below.

With regard to (A′), the similar device identification unit 22 estimates a degradation degree based on information that allows the cumulative load of the device 60 to be estimated, such as the cumulative mileage and the number of ON/OFF times of a relay circuit in the device 60. ON/OFF of the relay circuit can be identified by referring to the sensor data storage unit 311 in the operation data storage unit 31. For example, the similar device identification unit 22 sets weights depending on the number of ON/OFF times of the relay circuit, such as 1 if the number of ON/OFF times of the relay circuit is 0 to 99 times, 2 if it is 100 to 199 times, and 3 if it is 201 to 299 times. With regard to (B′), the similar device identification unit 22 sets weights based on the severity of damage expected for each device type. For example, the weights are set such as 5 if the device type is brakes and 6 if the device type is motor. Then, the similar device identification unit 22 calculates a value obtained by multiplying the weight related to (A′) and the weight related to (B′) as the importance degree.

### Effects of Embodiment 1

As described above, the data collection apparatus 10 according to Embodiment 1 increases the transmission amount of operation data regarding a similar device that is similar to a failed device. This makes it possible to collect operation data by focusing on devices that are likely to fail in the future, using the failed device in which a failure has occurred as a starting point. As a result, data indicating signs of failure occurrences can be sufficiently collected. By collecting data indicating signs of failure occurrences, it is possible to trace changes in the state of a device leading to deterioration.

In addition, it is possible to correlate the configuration of parts of the device 60 and the combination with other devices 60 stored in the device information storage unit 32 with transitions in state changes leading to deterioration of the device 60. This also makes it possible to estimate trends in deterioration of devices and promptly identify parts that may cause deterioration.

### ***Other Configurations***

### Variation 1

The similar device identification unit 22 may narrow down similar devices based on the similarity degree or the importance degree. That is, the similar device identification unit 22 may narrow down similar devices using at least one of a condition that the similarity degree is higher than a first threshold and a condition that the importance degree is higher than a second threshold. This makes it possible to narrow down the devices 60 whose transmission amount of operation data is to be increased.

### Variation 2

In Embodiment 1, the composition 50 includes one monitoring apparatus 70. However, the composition 50 may include a plurality of monitoring apparatuses 70. When the composition 50 includes the plurality of monitoring apparatuses 70, one monitoring apparatus 70 of the plurality of monitoring apparatuses 70 is a main monitoring apparatus 70 and each remaining monitoring apparatus 70 is a backup monitoring apparatus 70. The plurality of monitoring apparatuses 70 may share the target device 60 to be monitored. Alternatively, the plurality of monitoring apparatuses 70 may share transmission processing of operation data.

### Variation 3

In Embodiment 1, the functional components are realized by software. However, as Variation 3, the functional components may be realized by hardware. With regard to this Variation 3, differences from Embodiment 1 will be described.

When the functional components are realized by hardware, the data collection apparatus 10 includes an electronic circuit in place of the processor 11, the memory 12, and the storage 13. The electronic circuit is a dedicated circuit that realizes the functions of the functional components, the memory 12, and the storage 13.

When the functional components are realized by hardware, the monitoring apparatus 70 includes an electronic circuit in place of the processor 71, the memory 72, and the storage 73. The electronic circuit is a dedicated circuit that realizes the functions of the functional components, the memory 72, and the storage 73.

The electronic circuit is assumed to be a single circuit, a composite circuit, a programmed processor, a parallel-programmed processor, a logic IC, a GA, an ASIC, or an FPGA. GA is an abbreviation for gate array. ASIC is an abbreviation for application specific integrated circuit. FPGA is an abbreviation for field-programmable gate array.

The functional components may be realized by one electronic circuit, or the functional components may be distributed to and realized by a plurality of electronic circuits.

### Variation 4

As Variation 4, some of the functional components may be realized by hardware, and the rest of the functional components may be realized by software.

Each of the processor 11, the memory 12, the storage 13, and the electronic circuit is referred to as processing circuitry. That is, the functions of the functional components are realized by the processing circuitry.

### Embodiment 2

Embodiment 2 differs from Embodiment 1 in that a cloud is used as a platform to accumulate data. In Embodiment 2, this difference will be described, and description of the same aspects will be omitted.

### ***Description of Configuration***

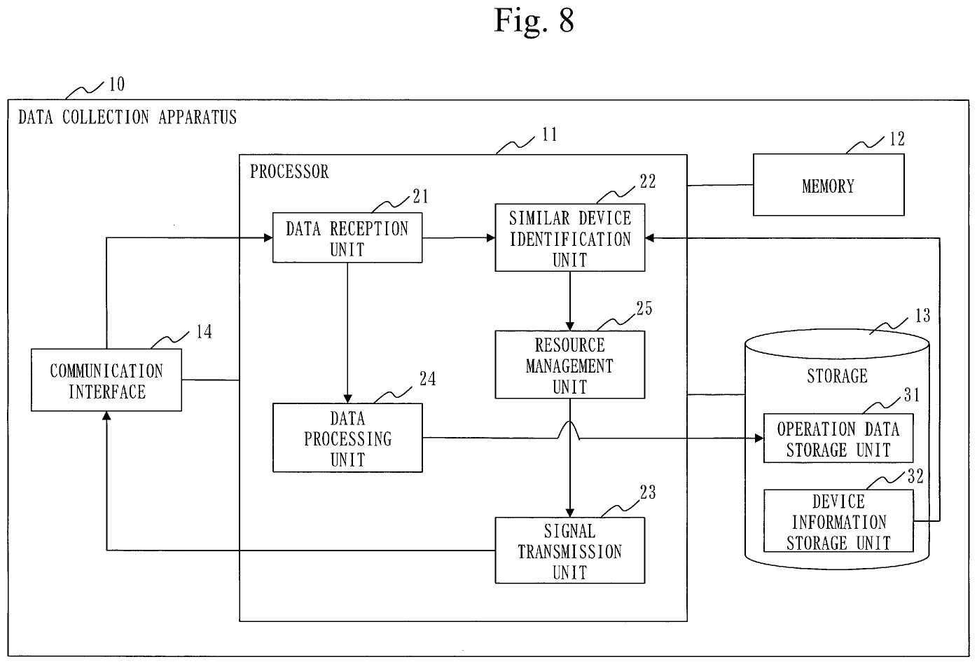

Referring to FIG. 8, a configuration of the data collection apparatus 10 according to Embodiment 2 will be described.

The data collection apparatus 10 differs from the data collection apparatus 10 indicated in FIG. 2 in that a resource management unit 25 is included as a functional component. The functions of the resource management unit 25 are realized by software or hardware, as with the other functional components.

### ***Description of Operation***

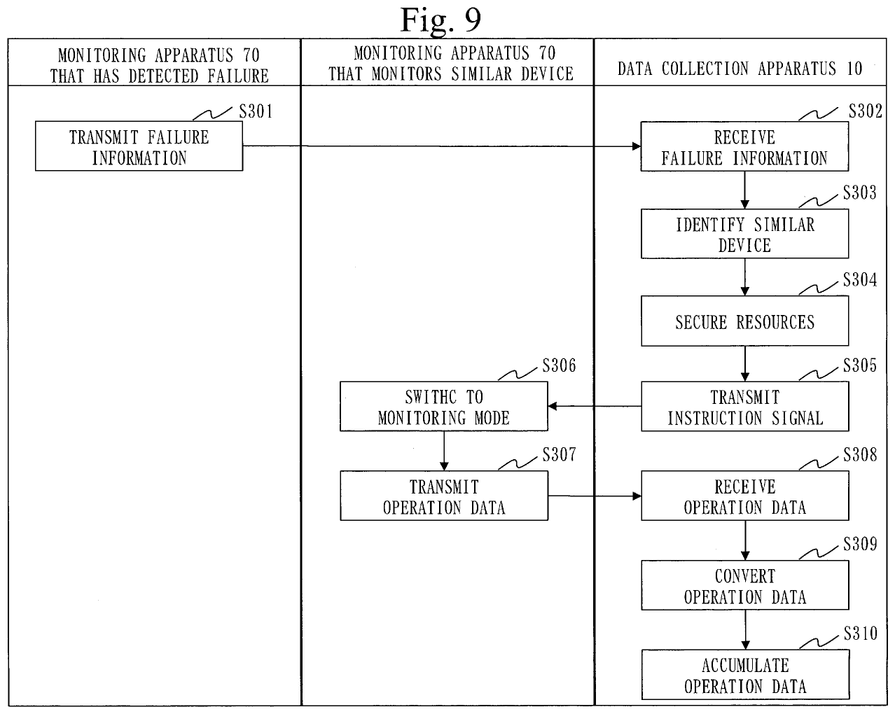

Referring to FIG. 9, a flow of operation of the data collection system 100 according to Embodiment 2 will be described.

The processes of steps S301 to S303 are the same as the processes of steps S101 to S103 in FIG. 4. The processes of steps S305 to S310 are the same as the processes of steps S104 to S109 in FIG. 4.

### (Step S304: Resource Management Process)

The resource management unit 25 secures increased computer resources (hereinafter referred to as resources) required for data processing by the data processing unit 24 due to an increase in the transmission amount of operation data regarding the similar device. In Embodiment 2, a cloud is used as a platform to accumulate data. Therefore, available resources can be increased.

Specifically, the resource management unit 25 performs the following processing. As the amount of data to be processed increases, the resources required for data processing also increase. The resource management unit 25 calculates a required increase of resources based on an increase in the transmission amount of operation data. Then, the resource management unit 25 secures the increased resources by changing the setting of the cloud.

For example, it is assumed that the amount of data that can be processed by one virtual server running on the cloud is 1 Mbit/second. Mbit is an abbreviation for megabit. It is also assumed that the amount of data transmitted from the monitoring apparatus 70 when the similar device is set to the monitoring mode is calculated as 10 Mbit/second. In this case, the resource management unit 25 secures ten virtual servers in advance. For simplicity, the data amount of operation data related to the device 60 set to the normal mode is assumed to be 0 here.

In this way, the amount of data transmitted by the device when the similar device is set to the monitoring mode (10 Mbit/second in the above example) is specified. This allows the resource management unit 25 to identify necessary resources by calculating a total amount of transmission data when each similar device is set to the monitoring mode.

The resource management unit 25 may reduce the secured resources if the transmission amount of operation data decreases for some reason.

### Effects of Embodiment 2

As described above, the data collection apparatus 10 according to Embodiment 2 uses a cloud as a platform to accumulate data. The data collection apparatus 10 secures in advance an increased amount of resources required for data processing by the data processing unit 24 due to an increase in the transmission amount of operation data. This makes it possible to prevent excessing processing time from being taken in processing to accumulate operation data due to a shortage of resources.

The data collection apparatus 10 according to Embodiment 2 may reduce the secured resources if the transmission amount of operation data decreases. This can prevent an increase in costs due to securing excessive resources.

### ***Other Configurations***

### Variation 5

There may be a case where the maximum amount of resources that can be secured is set by a contract of the cloud or the like. In such a case, it may not be possible to secure resources for the required increase in resources. If resources cannot be secured for the required increase in resources, the similar device identification unit 22 may narrow down similar devices. Specifically, the similar device identification unit 22 narrows down similar devices based on the similarity degree and the importance degree until the transmission amount is reduced to an amount that causes no shortage of resources.

For example, the amount of data that can be processed using all contracted servers on the cloud (the maximum amount of data that can be processed by the cloud) is assumed to be 10 Mbit/second. On the other hand, the transmission data amount of all similar devices is assumed to be 12 Mbit/second. In this case, the transmission data amount of the similar devices is expected to exceed the maximum amount of data that can be processed by the cloud. Therefore, the similar device identification unit 22 selects each similar device to be set to the monitoring mode one by one so that 10 Mbit/second is not exceeded from among the similar devices, starting with one with the largest multiplied value of the similarity degree and the importance degree. For simplicity, the data amount of operation data related to the device 60 set to the normal mode is assumed to be 0 here.

This can prevent excessive processing time from being taken in processing to accumulate operation data due to a shortage of resources.

### Embodiment 3

Embodiment 3 differs from Embodiments 1 and 2 in that a user is made to select the device 60 whose transmission amount of operation data is to be increased. In Embodiment 3, this difference will be described, and description of the same aspects will be omitted.

In Embodiment 3, a case where changes are made to Embodiment 2 will be described. However, it is also possible to make changes to Embodiment 1.

### ***Description of Configuration***

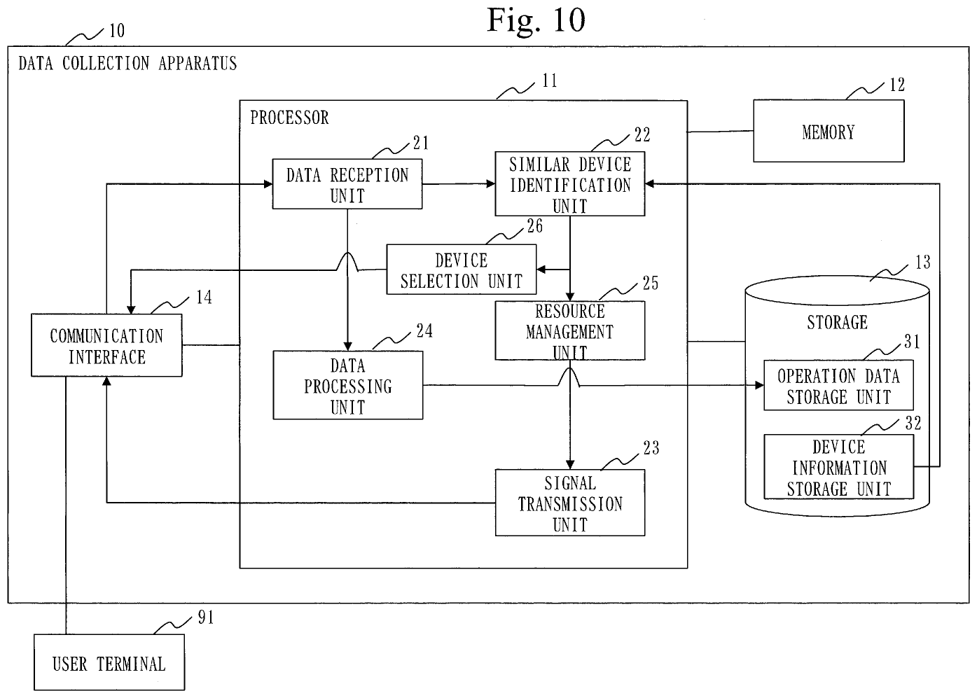

Referring to FIG. 10, a configuration of the data collection apparatus 10 according to Embodiment 3 will be described.

The data collection apparatus 10 differs from the data collection apparatus 10 indicated in FIG. 8 in that a device selection unit 26 is included as a functional component. The functions of the device selection unit 26 are realized by software or hardware, as with the other functional components.

In addition, the data collection apparatus 10 is connected with a user terminal 91 through the communication interface 14. The user terminal 91 is a computer operated by the user, such as a PC. PC is an abbreviation for personal computer.

### ***Description of Operation***

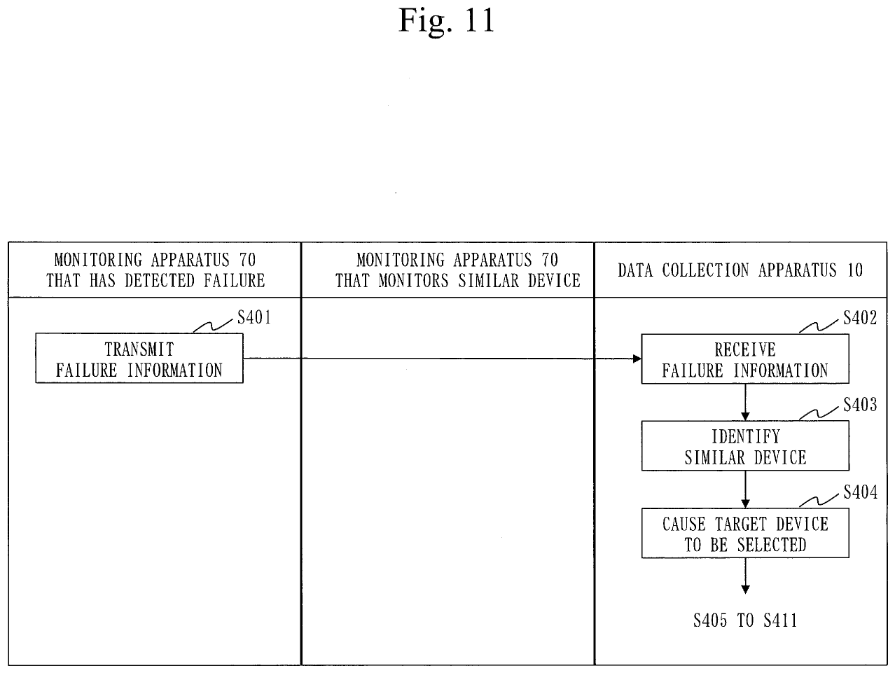

Referring to FIG. 11, a flow of operation of the data collection system 100 according to Embodiment 3 will be described.

The processes of steps S401 to S403 are the same as the processes of steps S301 to S303 in FIG. 9. The processes of steps S405 to S411 are the same as the processes of steps S304 to S310 in FIG. 9.

### (Step S404: Device Selection Process)

The device selection unit 26 transmits similarity information regarding each similar device identified in step S403 to the user terminal 91 so as to cause selection of a target device whose transmission amount of operation data is to be increased.

Specifically, the device selection unit 26 sets each of one or more similar devices as a target similar device. The device selection unit 26 sets information stored in the operation data storage unit 31 regarding the target similar device as similarity information regarding the target similar device. The information stored in the operation data storage unit 31 includes matching items, similarity degrees, and importance degrees. The device selection unit 26 transmits similarity information regarding every similar device to the user terminal 91 for display in a list. At this time, the device selection unit 26 may also transmit the information stored in the device information storage unit 32 with regard to the failed device to the user terminal 91 for display. Then, specification as to which similar device is set as a target device is accepted from the user terminal 91.

The device selection unit 26 limits similar devices to only each target device specified by the user terminal 91. That is, the device selection unit 26 excludes similar devices not specified by the user terminal 91.

The device selection unit 26 may include data on matching items in similarity information, and may display the data on matching items when the similarity information is displayed. For example, if the matching item between a similar device and a failed device is the part lot number group, the device selection unit 26 displays the lot number group of each of the similar device and the failed device.

Indexes may be assigned to similarity degrees and importance degrees when they are written to the operation data storage unit 31. The device selection unit 26 may use the indexes when displaying the similarity degrees and the importance degrees on the user terminal 91 so as to arrange them in ascending order, for example. This makes it easier for the user to select a similar device.

The items displayed on the user terminal 91 are not limited to similarity degrees, importance degrees, and matching items with a failed device. The information on a similar device or a failed device stored in the operation data storage unit 31 or the device information storage unit 32 may be displayed in combination with information such as weather, climate, and temperature information obtained from the Internet or the like.

### Effects of Embodiment 3

As described above, the data collection apparatus 10 according to Embodiment 3 displays information on similar devices and so on to cause the user to select the device 60 whose transmission amount of operation data is to be increased. This makes it possible to collect operation data regarding the device 60 from which the user wishes to collect operation data from a similar device similar to a failed device.

### Embodiment 4

Embodiment 4 differs from Embodiments 1 to 3 in that collected operation data of a similar device is displayed on the user terminal 91. In Embodiment 4, this difference will be described, and description of the same aspects will be omitted.

In Embodiment 4, a case where changes are made to Embodiment 3 will be described. However, it is also possible to make changes to Embodiments 1 and 2.

### ***Description of Configuration***

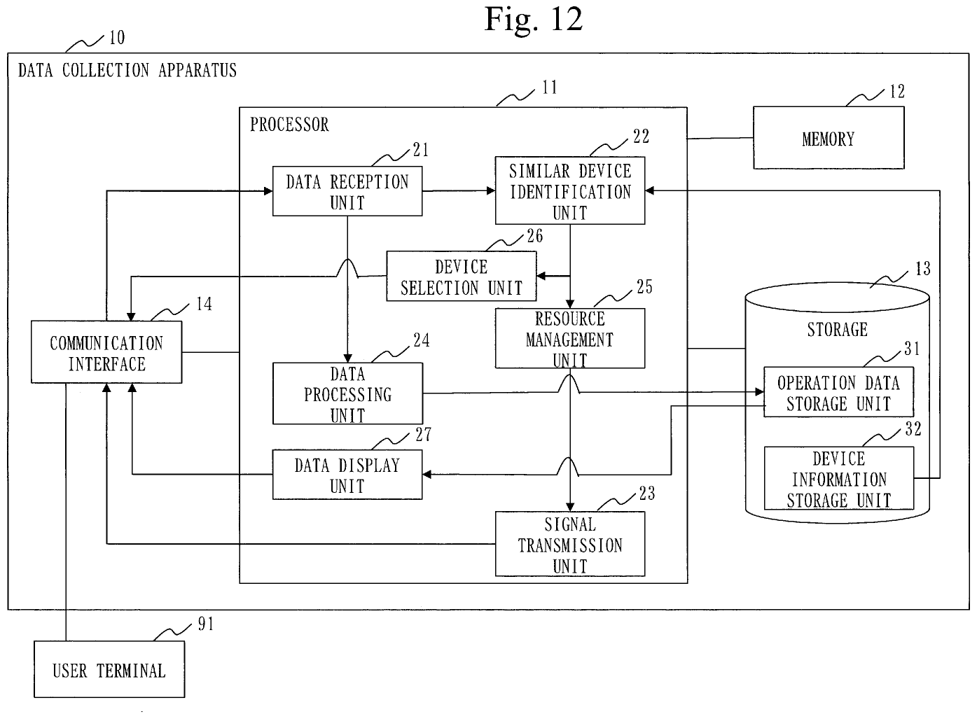

Referring to FIG. 12, a configuration of the data collection apparatus 10 according to Embodiment 4 will be described.

The data collection apparatus 10 differs from the data collection apparatus 10 indicated in FIG. 10 in that a data display unit 27 is included as a functional component. The functions of the data display unit 27 are realized by software or hardware, as with the other functional components.

### ***Description of Operation***

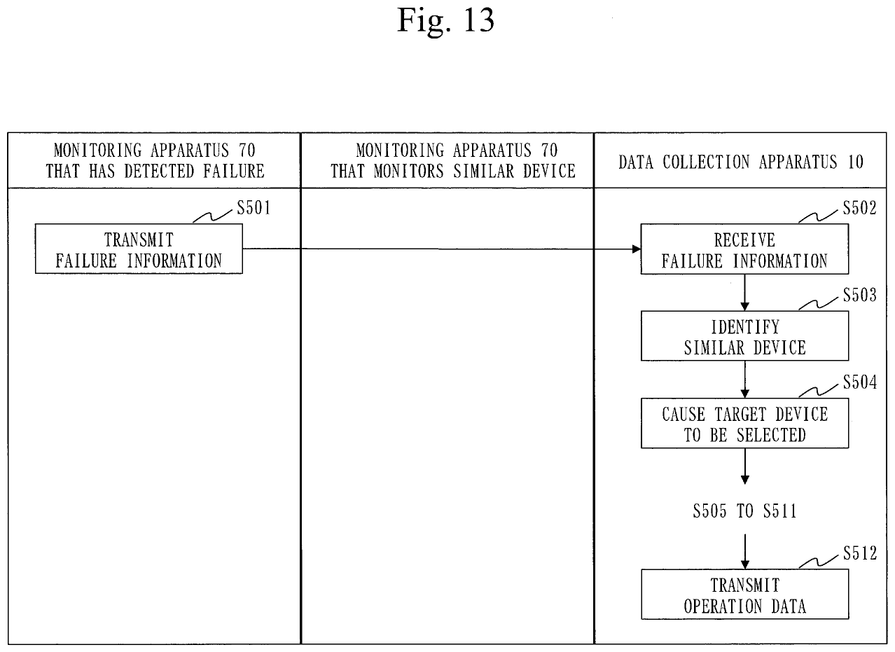

Referring to FIG. 13, a flow of operation of the data collection system 100 according to Embodiment 4 will be described.

The processes of steps S501 to S511 are the same as the processes of steps S401 to step S411 in FIG. 11.

### (Step S512: Data Display Process)

The data display unit 27 transmits, to the user terminal 91, operation data regarding the similar device specified from the user terminal 91 among the operation data received in step S508. As a result, the operation data is displayed on the user terminal 91.

Specifically, the data display unit 27 transmits a list of similar devices from which operation data has been collected to the user terminal 91 for display. Then, the data display unit 27 causes selection of a similar device whose operation data is to be referred to. When the similar device is selected, the data display unit 27 reads operation data of the selected similar device from the operation data storage unit 31. Then, the data display unit 27 transmits the operation data that has been read to the user terminal 91 for display.

### Effects of Embodiment 4

As described above, the data collection apparatus 10 according to Embodiment 4 displays collected operation data of similar devices on the user terminal 91. This allows the user to check operation data that is a sign of a failure.

“Unit” in the above description may be interpreted as “circuit”, “step”, “procedure”, “process”, or “processing circuitry”.

The embodiments and variations of the present disclosure have been described above. Two or more of these embodiments and variations may be implemented in combination. Alternatively, one of them or two or more of them may be partially implemented. The present disclosure is not limited to the above embodiments and variations, and various modifications can be made as necessary.

### REFERENCE SIGNS LIST

100: data collection system, 10: data collection apparatus, 11: processor, 12: memory, 13: storage, 14: communication interface, 21: data reception unit, 22: similar device identification unit, 23: signal transmission unit, 24: data processing unit, 25: resource management unit, 26: device selection unit, 27: data display unit, 31: operation data storage unit, 311: sensor data storage unit, 312: evaluation data storage unit, 32: device information storage unit, 321: design information storage unit, 322: production information storage unit, 323: configuration information storage unit, 324: operation information storage unit, 50: composition, 60: device, 61: sensor, 70: monitoring apparatus, 71: processor, 72: memory, 73: storage, 74: communication interface, 81: failure determination unit, 82: data transmission unit, 83: mode setting unit, 90: transmission channel, 91: user terminal.

1. A data collection apparatus comprising
processing circuitry to:
receive failure information indicating a failed device from one monitoring apparatus of one or more monitoring apparatuses each of which monitors a monitoring target device, the failed device being a device in which a failure has been detected;
identify a similar device that is the monitoring target device similar to the failed device indicated by the received failure information;
set, as a target monitoring apparatus, a monitoring apparatus that monitors the identified similar device among the one or more monitoring apparatuses, and transmit an instruction signal to increase a transmission amount of operation data of the similar device to the target monitoring apparatus, the instruction signal causing the transmission amount of the operation data to be increased by increasing the number of sensors that acquire the operation data;
perform data processing on the operation data; and
secure an increased amount of a resource used in the data processing due to an increase in the transmission amount of the operation data regarding the similar device,
wherein the processing circuitry identifies a plurality of the similar devices, and when the increased amount of the resource cannot be secured, narrows down the similar devices to one or more similar devices for which the resource can be secured.

2. The data collection apparatus according to claim 1,
wherein in each of the one or more monitoring apparatuses, a normal mode is set as an operation mode concerning the monitoring target device, the normal mode being a mode in which normal data obtained during operation is transmitted as the operation data at a normal cycle, and
wherein the processing circuitry transmits, to the target monitoring apparatus, an instruction signal to switch the operation mode concerning the similar device from the normal mode to a monitoring mode in which at least one of transmitting detailed data that is more detailed than the normal data as the operation data and transmitting the operation data at a shorter cycle than the normal cycle is performed.

3. The data collection apparatus according to claim 1,
wherein the processing circuitry determines whether the monitoring target device is similar to the failed device, depending on whether a match occurs between the monitoring target device and the failed device regarding at least one of a device model, a part that is a constituent of a device, a configuration of a composition in which a device is installed, and a use status of a composition in which a device is installed.

4. The data collection apparatus according to claim 2,
wherein the processing circuitry determines whether the monitoring target device is similar to the failed device, depending on whether a match occurs between the monitoring target device and the failed device regarding at least one of a device model, a part that is a constituent of a device, a configuration of a composition in which a device is installed, and a use status of a composition in which a device is installed.

5. The data collection apparatus according to claim 1,
wherein the processing circuitry displays similarity information regarding each identified similar device, so as to cause selection of a target device for which the transmission amount of the operation data is to be increased, and
wherein the processing circuitry sets a monitoring apparatus that monitors the target device as the target monitoring apparatus, and transmits an instruction signal to increase a transmission amount of operation data of the target device.

6. The data collection apparatus according to claim 2,
wherein the processing circuitry displays similarity information regarding each identified similar device, so as to cause selection of a target device for which the transmission amount of the operation data is to be increased, and
wherein the processing circuitry sets a monitoring apparatus that monitors the target device as the target monitoring apparatus, and transmits an instruction signal to increase a transmission amount of operation data of the target device.

7. The data collection apparatus according to claim 3,
wherein the processing circuitry displays similarity information regarding each identified similar device, so as to cause selection of a target device for which the transmission amount of the operation data is to be increased, and
wherein the processing circuitry sets a monitoring apparatus that monitors the target device as the target monitoring apparatus, and transmits an instruction signal to increase a transmission amount of operation data of the target device.

8. The data collection apparatus according to claim 4,
wherein the processing circuitry displays similarity information regarding each identified similar device, so as to cause selection of a target device for which the transmission amount of the operation data is to be increased, and
wherein the processing circuitry sets a monitoring apparatus that monitors the target device as the target monitoring apparatus, and transmits an instruction signal to increase a transmission amount of operation data of the target device.

9. The data collection apparatus according to claim 1,
wherein the processing circuitry displays the operation data regarding a specified device among the operation data transmitted from the one or more monitoring apparatuses.

10. The data collection apparatus according to claim 2,
wherein the processing circuitry displays the operation data regarding a specified device among the operation data transmitted from the one or more monitoring apparatuses.

11. The data collection apparatus according to claim 3,
wherein the processing circuitry displays the operation data regarding a specified device among the operation data transmitted from the one or more monitoring apparatuses.

12. The data collection apparatus according to claim 4,
wherein the processing circuitry displays the operation data regarding a specified device among the operation data transmitted from the one or more monitoring apparatuses.

13. The data collection apparatus according to claim 5,
wherein the processing circuitry displays the operation data regarding a specified device among the operation data transmitted from the one or more monitoring apparatuses.

14. The data collection apparatus according to claim 6,
wherein the processing circuitry displays the operation data regarding a specified device among the operation data transmitted from the one or more monitoring apparatuses.

15. The data collection apparatus according to claim 7,
wherein the processing circuitry displays the operation data regarding a specified device among the operation data transmitted from the one or more monitoring apparatuses.

16. The data collection apparatus according to claim 8,
wherein the processing circuitry displays the operation data regarding a specified device among the operation data transmitted from the one or more monitoring apparatuses.

17. A data collection method comprising:
receiving failure information indicating a failed device from one monitoring apparatus of one or more monitoring apparatuses each of which monitors a monitoring target device, the failed device being a device in which a failure has been detected;
identifying a similar device that is the monitoring target device similar to the failed device indicated by the failure information;
setting, as a target monitoring apparatus, a monitoring apparatus that monitors the similar device among the one or more monitoring apparatuses, and transmitting an instruction signal to increase a transmission amount of operation data of the similar device to the target monitoring apparatus, the instruction signal causing the transmission amount of the operation data to be increased by increasing the number of sensors that acquire the operation data;
performing data processing on the operation data;
securing an increased amount of a resource used in the data processing due to an increase in the transmission amount of the operation data regarding the similar device; and
narrowing down a plurality of the similar devices that have been identified to one or more similar devices for which the resource can be secured when the increased amount of the resource cannot be secured.

18. A non-transitory computer readable medium storing a data collection program that causes a computer to function as a data collection apparatus to perform:
a data reception process of receiving failure information indicating a failed device from one monitoring apparatus of one or more monitoring apparatuses each of which monitors a monitoring target device, the failed device being a device in which a failure has been detected;
a similar device identification process of identifying a similar device that is the monitoring target device similar to the failed device indicated by the failure information received by the data reception process;
a signal transmission process of setting, as a target monitoring apparatus, a monitoring apparatus that monitors the similar device identified by the similar device identification process among the one or more monitoring apparatuses, and transmitting an instruction signal to increase a transmission amount of operation data of the similar device to the target monitoring apparatus, the instruction signal causing the transmission amount of the operation data to be increased by increasing the number of sensors that acquire the operation data;
a data processing process of performing data processing on the operation data; and
a resource management process of securing an increased amount of a resource used in the data processing due to an increase in the transmission amount of the operation data regarding the similar device,
wherein in the similar device identification process, a plurality of the similar devices are identified, and when the increased amount of the resource cannot be secured by the resource management process, the similar devices are narrowed down to one or more similar devices for which the resource can be secured.

19. A data collection system comprising one or more monitoring apparatuses and a data collection apparatus, each of the one or more monitoring apparatus monitoring a monitoring target device,
wherein the data collection apparatus includes
processing circuitry to:
receive failure information indicating a failed device from one monitoring apparatus of the one or more monitoring apparatuses, the failed device being a device in which a failure has been detected;
identify a similar device that is the monitoring target device similar to the failed device indicated by the received failure information;
set, as a target monitoring apparatus, a monitoring apparatus that monitors the identified similar device among the one or more monitoring apparatuses, and transmit an instruction signal to increase a transmission amount of operation data of the similar device to the target monitoring apparatus, the instruction signal causing the transmission amount of the operation data to be increased by increasing the number of sensors that acquire the operation data;
perform data processing on the operation data; and
secure an increased amount of a resource used in the data processing due to an increase in the transmission amount of the operation data regarding the similar device,
wherein each of the one or more monitoring apparatuses includes
processing circuitry to:
switch an operation mode concerning the similar device from a normal mode to a monitoring mode upon receipt of the instruction signal; and
increase, when the operation mode is switched to the monitoring mode, the transmission amount of operation data of the similar device by increasing the number of sensors that acquire the operation data, compared to when the operation mode is the normal mode, and
wherein the processing circuitry of the data collection apparatus identifies a plurality of the similar devices, and when the increased amount of the resource cannot be secured, narrows down the similar devices to one or more similar devices for which the resource can be secured.

20. The data collection system according to claim 19, further comprising
a user terminal to display similarity information regarding the identified similar device, so as to cause selection of a target device for which transmission amount of the operation data is to be increased,
wherein the processing circuitry of the data collection apparatus sets a monitoring apparatus that monitors the target device as a target monitoring apparatus, and transmits an instruction signal to increase a transmission amount of operation data of the target device.
